(19) United States
(12) Patent Application Publication
(10) Pub. No.: US 2024/0111592 A1
(43) Pub. Date: Apr. 4, 2024

(54) METHOD, SYSTEM, AND COMPUTER READABLE MEDIA FOR ELASTIC HETEROGENEOUS CLUSTERING AND HETEROGENEITY-AWARE JOB CONFIGURATION

(71) Applicant: INFORMATICA LLC, Redwood City, CA (US)

(72) Inventors: Yongqin XIAO, Fremont, CA (US); Atam Prakash AGRAWAL, Fremont, CA (US)

(21) Appl. No.: 18/181,202

(22) Filed: Mar. 9, 2023

Related U.S. Application Data
(60) Provisional application No. 63/412,646, filed on Oct. 3, 2022.

(51) Int. Cl. G06F 9/50

(52) U.S. Cl. CPC G06F 9/5038; G06F 9/505; G06F 2209/5019; G06F 2209/505

(57) ABSTRACT

A method, application client, and non-transitory computer-readable medium for job scheduling on a heterogeneous cluster, including receiving an application comprising at least one job, the at least one job comprising one or more transformation units, determining a plurality of simulated performance scores for each transformation unit in the one or more transformation units, the plurality of simulated performance scores corresponding to a plurality of types of worker nodes in the heterogeneous cluster, determining a plurality of aggregate simulated performance scores for the at least one job, the plurality of aggregate simulated performance scores corresponding to the plurality of types of worker nodes, and transmitting instructions to the heterogeneous cluster configured to cause the heterogeneous cluster to schedule the at least one job on one or more nodes of the heterogeneous cluster based at least in part on the plurality of aggregate simulated performance scores.

### RELATED APPLICATION DATA

This application claims priority to U.S. Provisional Application No. 63/412,646, filed Oct. 3, 2022, the disclosure of which is hereby incorporated by reference in its entirety.

### FIELD

This disclosure relates generally to the field of data integration and specifically to data integration in a cloud computing environment.

### BACKGROUND

Vendors of cloud computing platforms help customer build and manage a cluster. Even though some vendors support spot instance as a cost saving measure, they are limited to implementing solutions utilizing a single node type in the whole cluster.

Nowadays, different cloud providers provide a wide range of instance types in different categories, such as general purpose, compute optimized, memory optimized, storage optimized, and accelerated computing (e.g., GPU, FPGA). Each specific instance category fits different use cases. For example, a CPU optimized instance is designated for CPU intensive applications but not for memory intensive applications. Similarly, not all applications can utilize accelerated computing on a GPU or FPGA, as running such jobs on these instances will waste the advanced resources.

Customers generally build a variety of applications with different optimization requirements to run on shared cluster(s) of a cloud computing platform. However, different applications and their component jobs require different resource configurations. Hence, there won't be one-size-fits-all solution for choosing an instance type for a homogeneous cluster. Running all applications on a fixed instance type will result in suboptimal performance, higher costs, and computing delays.

Known solutions for improving application performance while keeping costs down require customers to configure multiple clusters, each of a different instance type, and carefully assign applications to the best fitting cluster. Multiple clusters increase system costs, complicate application management, and are not a scalable solution for customers. Furthermore, with vendors increasingly pushing for more applications running on an advanced resource instance type like a GPU, tracking such changes and reconfigurations of the application to run on different clusters is untenable for customers.

Thus, there exists a need for a system to assign a job to the most efficient instance type that is both predictive, corrective, and scalable.

### BRIEF DESCRIPTION OF THE DRAWINGS

FIG. 1 illustrates a flowchart for job scheduling on a heterogeneous cluster according to exemplary embodiments.

FIG. 2 illustrates an exemplary embodiment of a heterogeneous cluster according to the present disclosure.

FIG. 3 illustrates an exemplary embodiment of a worker node group.

FIG. 4 illustrates an exemplary embodiments of determining an aggregate simulated preference score.

FIG. 5 illustrates an exemplary embodiments of a worker node group performance simulator.

FIG. 6 illustrates an exemplary matrix of one or more simulated performance scores for one or more transformation units and nodes of different instance types.

FIG. 7 illustrates an exemplary embodiment of heterogeneous cluster 700 in which one or more jobs are scheduled.

FIG. 8 illustrates an exemplary embodiments of scheduling one or more job on one or more worker node groups.

FIG. 9 illustrates a flowchart of steps for modifying a process of determining a plurality of simulated performance scores.

FIG. 10 illustrates an exemplary embodiment of modifying a process used to determine one or more simulated performance scores.

FIG. 11 illustrates a computing environment for scheduling one or more jobs on a heterogeneous cluster according to exemplary embodiments.

### DETAILED DESCRIPTION

In a data integration product, ETL jobs are known and commonly used. An ETL job refers to a three step process of data processing: (1) extract, (2) transform, and (3) load. At the data extraction step, data is extracted from one or more sources that can be from the same source system or different source systems. At the transform step, the extracted data is cleaned, transformed, and integrated into the desired state. Finally, at the load step, the resulting data is loaded into one or more targets on the same target system or different target systems.

An ETL job can be divided into one or more stages representing a smaller set of transformation units of the job. The transformation units of a given stage can generally be run together one after the other in a pipeline. A transformation unit is a single unit of work/computation configured to execute a series of instructions.

The data source (including source and target systems as discussed above) can be of different types, such as files, databases, or other applications, as well as of different complexities, such as a flat file, a Json, Avro, or parquet. This data can be located on a locally shared file system, such as an NFS, or on a remote distributed file system, such as an S3.

Different data source types require different data adapters to integrate the data as an ETL job (i.e. extract, transform, and load). Some data adapters are I/O intensive, for example when reading files from an NFS, some can be memory intensive, for example when reading parquet formatted files, and other can be CPU intensive, for example when reading Json for Json parsing.

The ETL job logic can be represented using SQL language, and thus can be processed by something like a SQL engine. That is, the ETL process, which can be, but is not limited to, a Spark can be divided into jobs, and jobs can be divided into stages, based on different parallelisms configured for extraction/transformation/loading, the needs for data shuffling, ordering of execution, etc. Each job or stage can run separately on a cluster with certain parallelism. It is thus possible to determine the best fitting instance type for a given job based on its computational and resource characteristics and assign a job to its ideal instance type. On a more granular level, it is also possible to determine best fitting instance types at the stage level.

Applicant has discovered a method, apparatus, and computer-readable medium that aims to schedule computing jobs on a heterogeneous cluster to overcome the drawbacks of using one or more homogeneous clusters.

While methods, apparatuses, and computer-readable media are described herein by way of examples and embodiments, those skilled in the art recognize that methods, apparatuses, and computer-readable media for scheduling jobs on a heterogeneous cluster are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “can” is used in a permissive sense (i.e., meaning having the potential to) rather than the mandatory sense (i.e., meaning must). Similarly, the words “include,” “including,” and “includes” mean including, but not limited to.

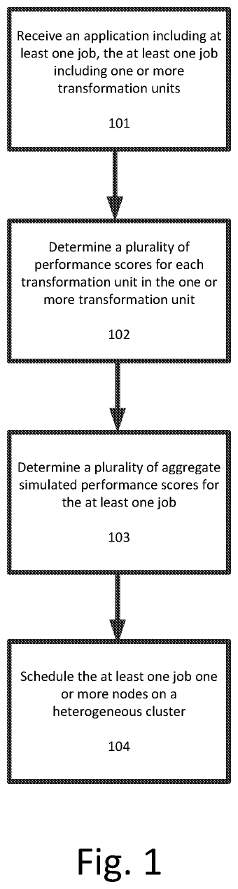

FIG. 1 illustrates a flowchart for scheduling jobs on a heterogeneous cluster according to exemplary embodiments of this disclosure. At step 101, one or more computing devices of an application client of a heterogeneous cluster environment can receive an application. The application can include one job or more than one job. Each job of the application can further include one or more transformation units. Each job can be divided into one or more stages that represent a subset of the one or more transformation units of the job. In various embodiments, each transformation unit can be configured to perform a transformation on data input to the transformation unit.

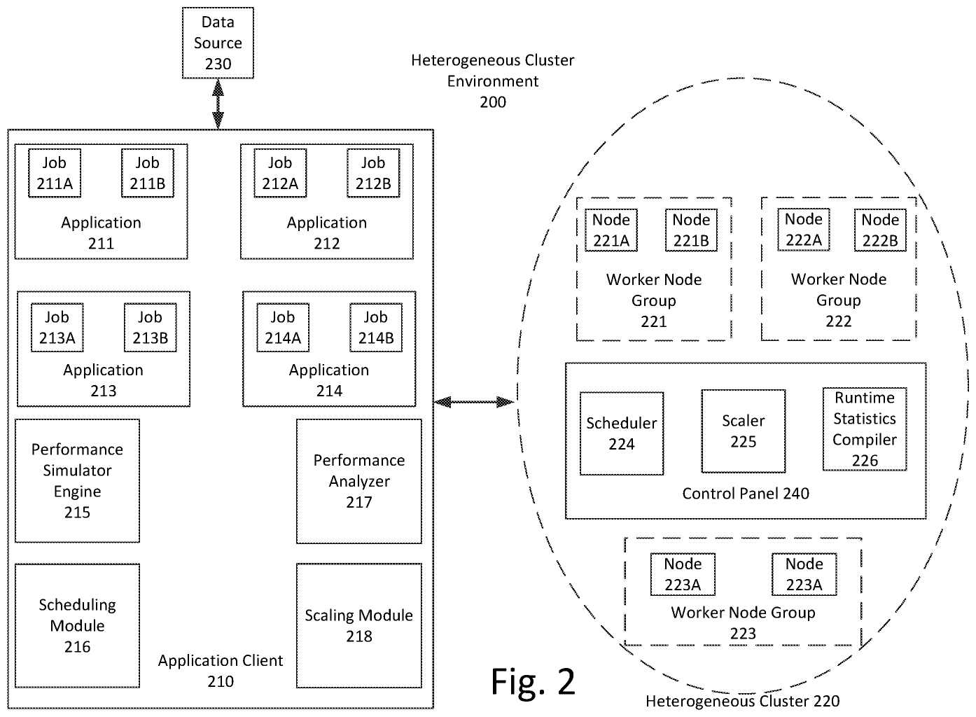

FIG. 2 illustrates an exemplary embodiment of a heterogeneous cluster environment 200 according to the present disclosure. The heterogeneous cluster can include an application client 210 and a heterogeneous cluster 220. Application client 210 can include one or more applications, e.g., 211, 212, 213, 214 received from a data source 230, each application including one or more jobs, e.g., 211A, 211B, 212A, 212B, 213A, 213B, 214A, and 214B.

Heterogeneous cluster 220 can include a plurality of worker node groups e.g., 221, 222, 223. Each worker node group can include one or more worker nodes, e.g., 221A, 221B, 222A, 222B, 223A, and 223B of the same instance type that correspond to a distinct hardware configuration. Each node of the one or more nodes in a group of worker nodes can be of the same instance type. For example, worker node group 221 can correspond to worker nodes of a X86_64 instance type, worker node group 222 can correspond to worker nodes of an ARM64 instance type, and worker node group 223 can correspond to worker nodes of a GPU instance type.

Heterogeneous cluster 220 can further include a scheduler 224 for scheduling the one or more jobs of the one or more applications on the one or more nodes of heterogeneous cluster 220, a scaler 225 for scaling the one or more worker nodes based on a workload of one or more nodes of heterogeneous cluster 220, and a runtime statistics compiler 226 for compiling runtime statistics about the execution of the one or more jobs on the one or more nodes of heterogeneous cluster 220. Runtime statistic can include, but are not limited to, an execution time, a number of data partitions, data being processed (e.g., a number of bytes being read and written), an amount of shuffle data, which hardware component is being used, etc. Scheduler 224, scaler 225, and runtime statistics compiler 226 can be located on a control panel 240 that represents a master node of heterogeneous cluster 220. While not illustrated, scheduling module 224, scaling module 225, and runtime statistics compiler 226 are communicatively coupled with each worker node group and node of heterogeneous cluster 220.

Application client 210 can include a performance simulator engine 215 for simulating a transformation on data input from the one or more transformation units of the one or more jobs, a scheduling module 216 for transmitting instructions to control panel 240 that can cause scheduler 224 to schedule the one or more jobs for execution on the one or more nodes of heterogeneous cluster 220, a performance analyzer 217 for analyzing a runtime performance of each of the one or more jobs executed on the one or more nodes of heterogeneous cluster 220, and a scaling module 218 for transmitting instructions to control panel 240 of heterogeneous cluster 220 to set configuration parameters of the scaler 225 and to cause scaler 225 to scale the one or more nodes of heterogeneous cluster 220.

A person of ordinary skill in the art will appreciate that the number and combination of instance types illustrated in FIG. 2 is merely one example of a combination of instance types and that many different combinations of instance types can be implemented without departing from the scope and spirit of the present disclosure. For example, heterogeneous cluster 220 may include one worker node group, two worker node groups, or 5 worker node groups. The worker node groups can each be of a different instance type, as illustrated in FIG. 2, or there can be more than one worker node group for a particular instance type.

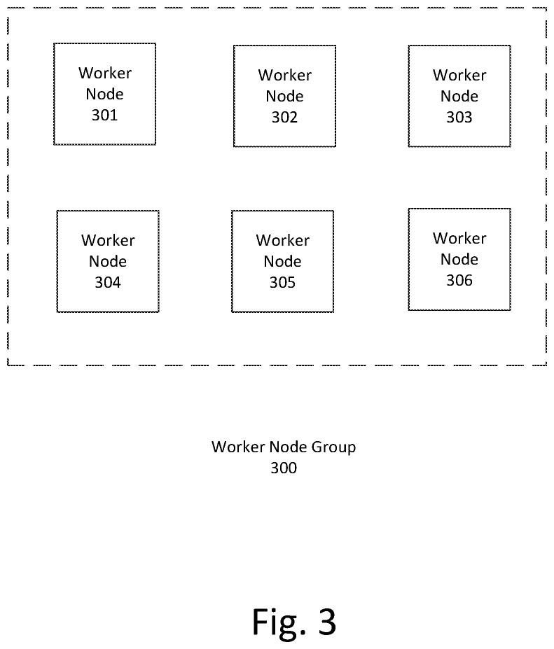

FIG. 3 illustrates an exemplary embodiment of a worker node group 300 having a plurality of worker nodes 301, 302, 303, 304, 305, and 306. In various embodiments, each worker node of the plurality of worker nodes corresponds to a same instance type representing a distinct hardware configuration. Examples of types of worker nodes include, but are not limited to, general purpose instances types such as X86_64 and ARM64, and instance types with accelerated computing power, such as GPU. Worker node group 300 can include more than one worker node, as presented in FIG. 3, or worker node group 300 can include one worker node.

At step 102, a plurality of simulated performance scores for each transformation unit of the one or more transformation units of the job can be determined. In various embodiments, each performance score can correspond to a particular worker node type in heterogeneous cluster 220. Each simulated performance score of the plurality of performance scores can represent a node type preference of each corresponding transformation unit, reflecting a resource requirement of the transformation performed by the transformation unit. The plurality of simulated performance scores can additionally or alternatively be based on a computational nature of a respective transformation unit and/or a configuration nature of the respective transformation unit. In various embodiments, application client 210 can determine the plurality of simulated performances scores using performance simulator engine 215.

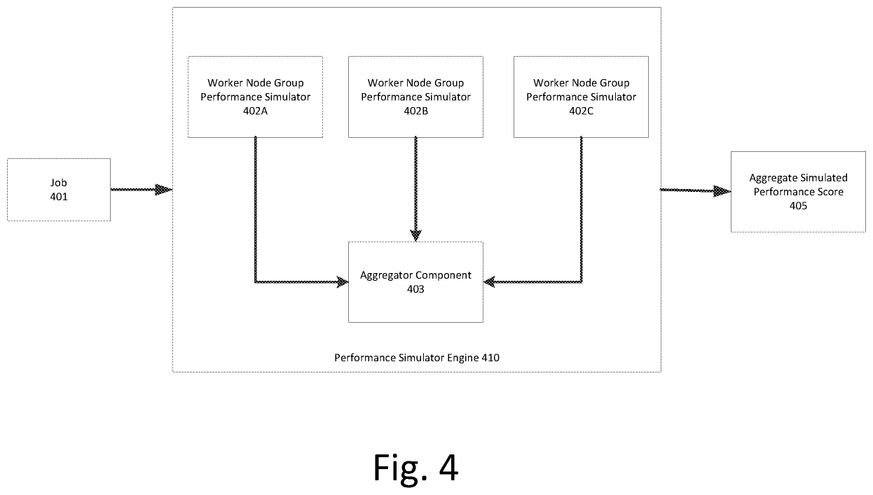

FIG. 4 illustrates an exemplary embodiment of a performance simulator engine. As illustrated, performance simulator engine 410 can receive input data corresponding to one or more transformation units of a particular job 401. Performance simulator engine 410 can include one or more worker node group performance simulators 402A, 402B, and 402C corresponding to an instance type representing a distinct hardware configuration. Each worker node group performance simulator can simulate the transformations of the one or more transformation units of job 405 and assign a simulated performance score for each transformation. The simulated performance score can be determined by the resources required for the transformation performed by the transformation unit and the distinct hardware configuration of the corresponding instance type of the worker node group performance simulator, e.g., 402A, 402B, and 402C.

Alternatively, performance simulator engine 410 can determine a plurality of simulated performance scores based in part on duplicate data designed to mimic the data requirements of the transformation units of a job and simulate performance scores for each transformation based on the duplicate data. In other words, performance simulator engine 410 may determine a simulated preference score based on simulated data that mimics the transformations of the transformation units of the job. In other embodiments, performance simulator engine 410 can determine a plurality of simulated performance scores based in part on the actual data from the transformation units of a job of an application.

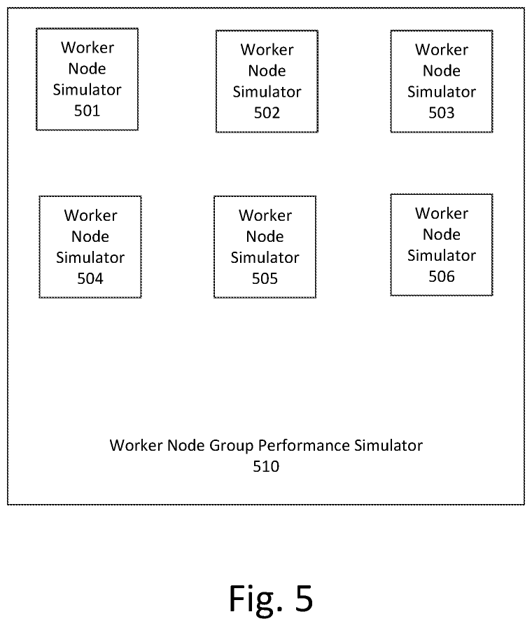

FIG. 5 illustrates an exemplary embodiment of a worker node group performance simulator 510. Worker node group performance simulator 510 can include one or more worker node simulators, e.g., 501, 502, 503, 504, 505, and 506, that determine a plurality of simulated performance scores based in part on duplicate data designed to mimic the data requirements of the transformation units of a job.

In various embodiments, the resources required for a transformation of a particular transformation unit can depend on the computation nature and resource configuration of a transformation. The computation nature can in part define the primary resource consumption of a particular transformation unit of a job. By way non-limiting example, the computation nature of a given transformation unit can be determined from a transformation logic of the corresponding transformation unit. For example, some transformation units require cumulative data to execute a transformation. This transformation unit can be considered as having a memory intensive computation nature because the data cumulates in memory and down to disc if needed. As another example, transformation units with expressions having floating point calculations can be computationally intensive and therefore have greater CPU consumption. As yet another example, some transformation units can be I/O intensive. In other words, the computation nature of a transformation unit can be associated with an instance type on which the transformation of the transformation unit can be optimally performed and can therefore inform a corresponding simulated performance score.

The resource configuration of a transformation unit can reflect a set of computation resources required by the transformation unit and can further define the resource consumption nature of the transformation unit. For example, a transformation unit that is set with a relatively large amount of memory has a resource configuration that is memory consuming because the transformations will be executed on the large amount of memory. Alternatively, a transformation unit that is set with a relatively small amount of memory will use less memory resources. In another example, the resource configuration can indicate that a large amount of processing power is required for the transformation unit (e.g., O(N^{c})), where “N” is the amount of data, “c” is a constant, in which case the transformation unit may be well-suited for a GPU.

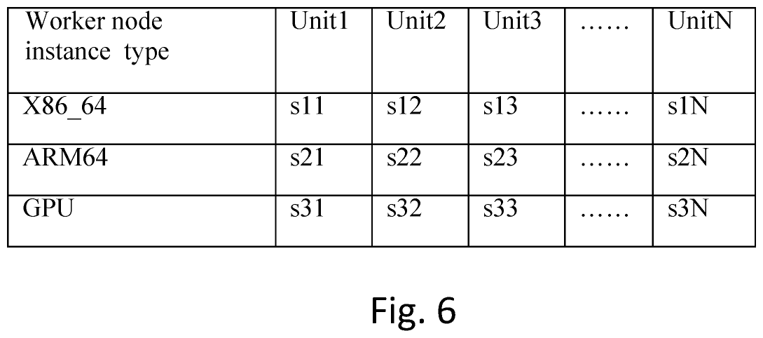

As illustrated in FIG. 6, a plurality of simulated performance scores can be visually represented by a matrix of simulated preference scores for each transformation unit. For example, in heterogeneous cluster environment 200 illustrated in FIG. 2, a transformation unit that is not supported by the ARM64 group node 223 because of unavailable libraries can receive a simulated preference score s21 of negative infinity for ARM64 group node 203, indicating a complete inability to execute the transformation. Alternatively, an inability to execute a given transformation can correspond to some other negative value. If that same transformation unit is not implemented for GPU-level execution, then a GPU simulated preference score s31 can be some relatively small positive number or zero, indicating an ability to execute the transformation, but with a lower preference for it. If the transformation unit prefers the X86_64 group node, then a simulated preference score s11 can be a larger positive number, indicating both an ability to execute the transformation and a greater preference for executing the transformation. In other words, the greater the score, the more effective the expected preference for the corresponding instance type. A simulated preference score can be determined for each transformation unit up to a transformation unit N for each group node type.

In various embodiments, a weight can be assigned to each transformation unit. The weight can be determined by, for example, a relative computational complexity of the transformation unit and/or a data cardinality of the transformation unit. By way of non-limiting example, a transformation unit that does address validation against an address dictionary can be a more time consuming transformation than a regular transformation and would thus be assigned a higher weight than a transformation unit that performs a regular transformation. As another non-limiting example, a transformation unit that performs a joiner transformation that calculates a Cartesian product of two source transformation units can be assigned a higher weight than the two source transformation units. This is because the joint transformation that calculates the Cartesian product of two sources can bloat the data volume.

At step 103, a plurality of aggregate simulated performance scores for the at least one job can be determined. Each aggregate simulated performance score of the plurality of aggregate simulated performance scores can correspond to each of the one or more worker node group performance simulators representing a distinct instance type. Each aggregate simulated performance score can be determined at least in part on the plurality of simulated performance scores corresponding to the worker node group performance simulator of a certain instance type for each of the plurality of transformation units for the corresponding job.

In various embodiments, each aggregate simulated performance score corresponding to a worker node group can be determined according to the following equations, where there are three different instance types corresponding to a worker node group performance simulators, e.g., 402A, 402B, and 402C:

X86_64 score=(w1*s11+w2*s12+w3*s13+ . . . +wN*s1N)/N;

ARM64 score=(w1*s21+w2*s22+w3*s23+ . . . +wN*s2N)/N;

GPU score=(w1*s31+w2*s32+w3*s33+ . . . +wN*s3N)/N,
where N is the total number of transformation units for the corresponding job.

The greatest positive aggregate simulated performance score can represent the node type preference of the corresponding job. In various embodiments, a weighting value w can be assigned to each simulated performance score. Alternatively, a weighting value w can be assigned to each aggregate simulated performance score. The weighting value can be user defined and reflect a preference for scheduling a job on a worker node group of a given instance type. In this way, a user may override the worker node type selection determined by the raw aggregate simulated performance scores. In other embodiments, the weighting value can be determined based in part on the particular heterogeneous cluster environment. For example, a heterogeneous cluster having large number of worker node groups of GPU computing may assign a positive weighting value reflecting a scheduling preference for GPU nodes. Alternatively, a negative weighting value can be assigned to reflect a preference for not scheduling a job on a worker node group of a specific instance type.

In an alternative embodiment, a plurality of aggregate simulated performance scores can be determined at a stage-level. As discussed above, a stage includes one or more transformation units and can be a subset of a job. Each stage-level aggregate simulated performance score can correspond to each of the one or more worker node group performance simulators representing a distinct instance type. Each stage-level aggregate simulated performance score can be determined at least in part on the plurality of simulated performance scores corresponding to the worker node group performance simulator of a certain instance type for each of the plurality of transformation units for the corresponding stage. Determining an aggregate simulated performance score at the stage-level can improve the accuracy of scheduling the job on the most efficient node type because it silos transformation units into smaller groups. This can more accurately reflect the instance type preference because it prevents a particularly low performance score for a single transformation unit from skewing the aggregate performance score of the entire job.

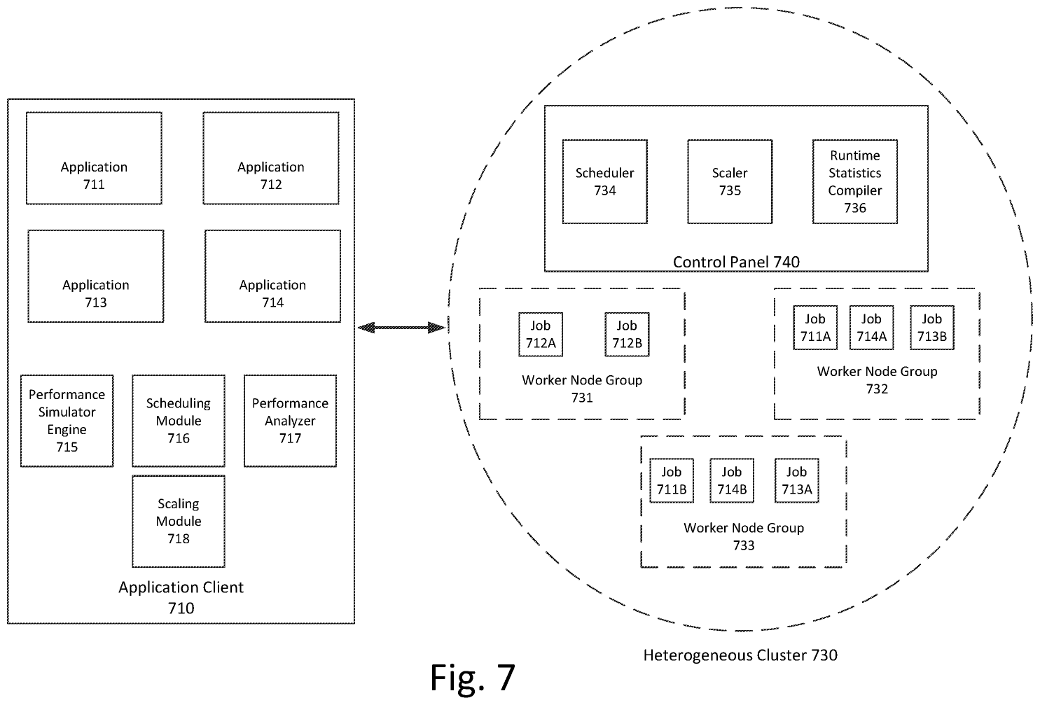

At step 104, the at least one job can be scheduled on one or more nodes of the one or more worker node groups of a heterogeneous cluster. As illustrated in FIG. 7, scheduling module 716 of an application client 710 can transmit instructions to a control panel 740 of a heterogeneous cluster 730 that cause a scheduler 734 to schedule the at least one job on one or more nodes of heterogeneous cluster 730 based on the plurality of aggregate simulated performance scores. Instructions can cause scheduler 734 to schedule a job to a node of an instance type for which the greatest aggregate simulated performance score corresponds. Alternatively, instructions can cause scheduler 734 to schedule a job a node of heterogeneous cluster 730 that is available for scheduling, which may not necessarily correspond to a node of an instance type for which the greatest aggregate simulated performance score corresponds. For example, by way of non-limiting example, a job can have three aggregate simulated performance scores determined by performance simulator engine 715, each score corresponding to a distinct worker node group for X86_64, ARM64, and GPU instance types, respectively. If the X86_64 aggregate simulated performance score is the largest positive value, then the job can be scheduled on the worker node group corresponding to a X86_64 instance type. However, if the worker node group has no available nodes, then the job may be scheduled on the worker node group of instance type with the next greatest aggregate simulated performance score that is capable of executing the transformations of the transformation units of the job. In such embodiments, a job may not be scheduled on a worker node group of an instance type with a negative aggregate simulated performance score or with an aggregate simulated performance score of zero because such aggregate simulated performance scores represent an incompatibility between the transformations of the job and the corresponding instance type.

As yet another example, scheduling 104 at least one job may include scheduling a CPU job on a GPU node. Each GPU node has both GPU resources and CPU resources, and can therefore execute a GPU job, a CPU job, or both at the same time. In order to fully utilize the CPU and GPU resources of the GPU node, scheduling a CPU job on a GPU node can occur when the GPU node is already running a job on its GPU resources. Otherwise, if the GPU node is not already running a job on its GPU resources, then the GPU node will not be efficiently utilized, because then the GPU node will be utilizing only its CPU resources without using its GPU resources. In this case, the GPU node would run only a CPU job and prevent scheduling of a GPU job on its GPU resources, effectively wasting the GPU resources of that node.

Scheduling 104 the job on one or more nodes of the one or more worker node groups of the heterogeneous cluster may also be based in part on one or more stage-level aggregate simulated performance scores. In various embodiments, the job can be scheduled on the worker node group corresponding to the instance type having the greatest number of positive stage-level aggregate simulated performance scores. This can help schedule the job on the most efficient worker node group because it provides a more granular and detailed representation of the execution of the job on a particular instance type.

For example, a job having 10 stages is submitted to application client, e.g., 210, 710, for scheduling. A plurality of simulated performance scores are determined for one or more transformation units of the job for each instance type of one or more worker node groups. Then, a stage-level aggregate simulated performance score is determined by aggregating each simulated performance score for the one or more transformation units of each stage of the job, resulting in 10 stage-level aggregate simulated performance scores for each instance type of one or more worker node groups. Each job can then be scheduled based on the stage-level aggregate simulated performance scores.

When scheduling 104 a job based on stage-level aggregate simulated performance scores, if the greatest number of positive stage-level aggregate simulated performance scores corresponds to a GPU instance type, for example, then the job can be scheduled on a GPU worker node group. Alternatively, the job can be scheduled on a node of a different worker node group even though the greatest number of positive stage-level aggregate simulated performance scores corresponds to a GPU instance type. For example, the scores for other stages in the job may be zero, indicating that a GPU instance type is not a preferred instance type of those particular stages. If the stage-level aggregate simulated performance scores for those stages for an X86_64 instance type are positive, then the job can be scheduled on nodes of X86_64 instance type. Therefore, a more efficient scheduling of the job is on the X86_64 worker node group, even if the number of positive stage-level aggregate simulated performance scores for the GPU is greater than the number of positive stage-level aggregate simulated performance scores for the X86_64.

In various embodiments, scheduling the job can include checking the availability of the one or more nodes of the worker node group corresponding to the instance type of the greatest aggregate simulated performance score.

FIG. 7 illustrates an exemplary embodiment of heterogeneous cluster environment 700 in which one or more jobs, e.g., 711A, 711B, 712A, 712B, 713A, 713B, 714A, and 714B of one or more applications, e.g., 711, 712, 713, and 714 are scheduled by a scheduler 734 of heterogeneous cluster 730 on nodes of a corresponding worker node group 731, 732, and 733 of heterogeneous cluster 730. As illustrated, one or more jobs from a single application can be scheduled on different worker node groups, e.g., job 711A, 714A, and 713B on worker node group 732, depending on the aggregate simulated performance score for each respective job. In some embodiments, one or more jobs from a single application can be scheduled on the same worker node group, e.g., job 712A and 712B on worker node group 731.

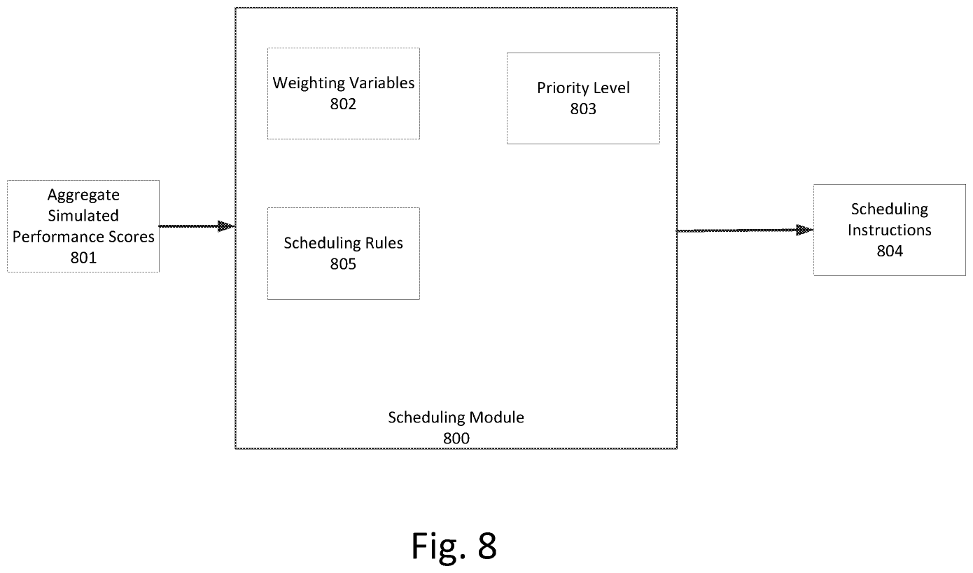

FIG. 8 illustrates an exemplary embodiment of a scheduling module for scheduling one or more jobs on one or more worker node groups. Scheduling module 800 can receive one or more aggregate simulated performance scores 801 from a transformation performance simulator, e.g., 215, 715, and apply one or more weighting variables 802, one or more priority levels 803, and one or more scheduling rules 805 to the each of the one or more aggregate simulated performance scores 801 and output scheduling instructions 804 that cause a scheduler, e.g., 224, 734, to schedule a job on a node of a worker node group of a heterogeneous cluster, e.g., 220, 730. Aggregate simulated performance scores 801 can be job-level, stage-level, or both. In various embodiments, a weighting variable can reflect an instance type preference of a job of the one or more jobs that is based in part on the configuration of characteristics of the heterogeneous cluster, including, but not limited to, overall computing power or a number of nodes in a worker node group. Weighting variables 802 can also be based on user selected preferences.

Scheduling rules 805 can include rules about how scheduling module 800 applies the one or more aggregate simulated performance scores 801 to a scheduling decision. For example, scheduling rules 805 may define a threshold score for scheduling one or more jobs on a particular worker node group instance type even where the corresponding score is not the greatest positive score. In such embodiments, scheduling module 800 can schedule the job to the worker node group of instance type corresponding to the score that exceeds the threshold value and not schedule the job on the worker node group of instance type corresponding to the score that is the greatest positive score. This threshold score can be defined at the stage level or the job level. As another non-limiting example, a scheduling rule 805 may define a maximum number of jobs that can be scheduled on a given worker node group.

In various embodiments, the at least one job can be scheduled based on both the aggregate simulated performance score 801 and a priority level 803. For example, a service-level agreement of an application or a user-configured job priority can define a priority level for the one or more applications running on the heterogeneous cluster. In such embodiments, the one or more jobs of an application having a higher priority can be scheduled before the one or more jobs of an application having a lower priority even if the lower priority application has a higher aggregate simulated performance score than the higher priority applications having a lower aggregate simulated performance score. In various embodiments, an application with a low priority may not be scheduled on a computationally accelerated node (e.g., a GPU node). A priority level 803 can be an application priority level indicating a priority for scheduling one or more jobs from a particular application. Alternatively or additionally, a priority level 803 can be a job priority level indicating a priority for scheduling a particular job.

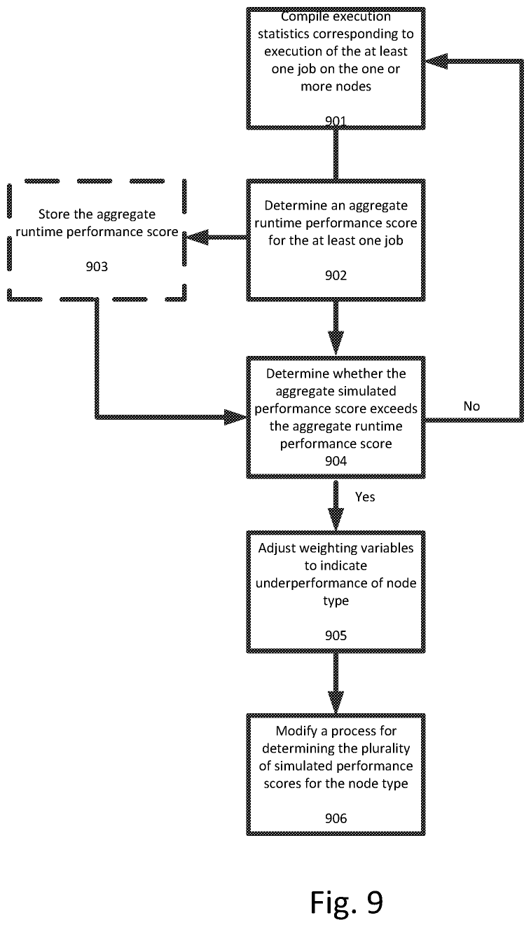

FIG. 9 illustrates a flowchart of an exemplary embodiment for evaluating the performance of one or more scheduled jobs on one or more nodes of a worker node group. At step 901, one or more sets of execution statistics corresponding to the execution of one or more scheduled jobs on one or more nodes of a worker node group can be compiled by a runtime statistics compiler, e.g., 226, 736, that is on heterogeneous cluster 730. Statistics about the execution of the one or more jobs can include but is not limited to, an execution time, a number of data partitions, data being processed (e.g., a number of bytes being read and written), an amount of shuffle data, or which hardware component is being used. Alternatively, execution statistics can correspond to the execution of one or more stages of the job in a stage-level implementation.

At step 902, an aggregate runtime performance score for the at least one job can be determined. In various embodiments, performance analyzer 717 of application client 710 can analyze the one or more runtime statistics received from runtime statistics compiler, e.g., 226, 736. Alternatively, a plurality of stage-level aggregate runtime performance score for the at least one job can be determined based on stage-level runtime statistics. Optionally, at step 903, the aggregate runtime performance score can be stored on a database.

At step 904, the aggregate runtime performance score can be compared with the simulated performance score corresponding to the instance type of the scheduled job. If the aggregate simulated performance score exceeds the aggregate runtime performance score, method 900 proceeds to step 905. Alternatively, the aggregate runtime performance score of one or more stages of the job can be compared with the corresponding stage-level aggregate simulated performance scores. The aggregate runtime performance score exceeding the aggregate simulated performance score can indicate that the aggregate simulated performance score did not predict a performance of the job on the one or more nodes of the worker node group of a particular instance type with sufficient accuracy and therefore did not result in the an efficient scheduling of the job on the one or more worker node groups.

If the aggregate simulated performance score does not exceed the aggregate runtime performance score, then method 900 returns to step 901. In other words, the aggregate runtime performance score is determined to be at least as high as the aggregate simulated performance score, indicating that the job was scheduled on an efficiently instance type of the one or more worker node groups. Alternatively, if the difference between the aggregate runtime performance score and the aggregate simulated performance score does not exceed a threshold value, then the method returns to step 901. In other words, there can be an allowed margin of error in which the scheduling is regarded as efficient, even if the aggregate simulated performance score is greater than the aggregate runtime performance score.

At step 905, one or more healing variables can be assigned to the worker node group that is executing the scheduled job to reflect the underperformance of the scheduled job on the instance type of the corresponding worker node group. One or more healing variables can be assigned to the worker node group executing the scheduled job in order to de-emphasize the instance type of the worker node group because the actual runtime performance of the job on nodes of that instance type was reduced compared to the simulated performance of the same job on nodes of the same instance type (as reflected in the aggregate simulated performance score). One or more healing variable can therefore be used to inform subsequent scheduling of the job on the one or more worker node groups.

In various embodiments, the one or more variables can be a numerical value that can decrease the aggregate simulated performance score for the corresponding instance type for the scheduled job, thus indicating a decreased performance level of the one or more transformation units of the corresponding job on the instance type of the worker node group executing the job. In other embodiments, one or more healing variables can include a flag denoting the instance type of the worker node group that underperformed the execution of the scheduled job. These embodiments of healing variables are merely illustrative and are not intended to limit the scope of this disclosure in any way. Any variable assigned to reflect an underperformance of an instance type for a particular job is contemplated by the present disclosure.

At step 906, a process used to determine the one or more simulated performance scores for the corresponding instance type can be modified. In various embodiments, the aggregate runtime performance score can be used to modify the process for determining a simulated performance score. An example of a process for determining one or more simulated performance scores is illustrated in FIG. 4.

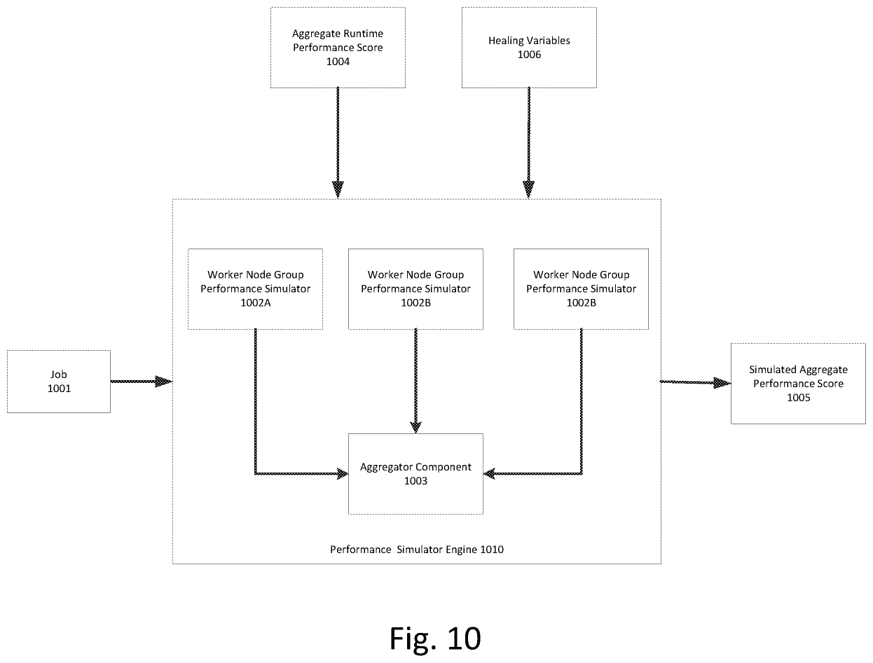

FIG. 10 illustrates an exemplary embodiment of modifying 906 a process used to determine one or more simulated performance scores based on a corresponding aggregate runtime performance score. A performance simulator engine 1010 can receive a job 1001 and determine a simulated aggregate performance score 1005 as described with reference to FIG. 4. Performance simulator engine 1010 can further receive one or more aggregate runtime performance scores corresponding to one or more respective instance types that reflect the runtime performance of job 1001 on one or more nodes of the particular instance type. Aggregate runtime performance score 1004 can be used by a worker node group performance simulator, e.g., 1002A, 1002B, and 1003C, of a matching instance type in order to produce a simulated performance score for one or more transformation units of job 1001 that is modified based on the aggregate runtime performance score 1004. Because the aggregate runtime performance score represents the performance of the one or more transformation units of a job on nodes of a particular instance type, it can be used as input by performance simulator engine 1010 in future simulations of that job, or stages of that job, on nodes of that particular instance type. In the event that the aggregate runtime performance score varies greatly from the simulated aggregate performance score, it can be used in place of the simulated aggregate performance score for the job and type of worker node and/or to heal the simulated aggregate performance score, as discussed previously.

For example, if the aggregate runtime performance score demonstrates poor execution of the job on nodes of a GPU instance type, then performance simulator engine 1010 can correct the simulated performance scores of the transformation units of that job in future submissions of that same job. After execution of the job a first time, the aggregate runtime performance score can indicate that the GPU node did not efficiently execute the one or more transformation units of the job. For example, a job having 10 transformation units is scheduled to run on a GPU node because the greatest aggregated simulated performance score for the job corresponds to the GPU instance type. However, when actually executed on the GPU worker node group, only 6 of the 10 transformation units are executed by the GPU components of the GPU nodes and 4 of the 10 transformation units are executed by the CPU components of the GPU nodes. Because CPU computation is row based and GPU computation is column based, transformation units would need to be converted between row and column representations, resulting in inefficiencies of the overall execution of the job. These inefficiencies can cause the aggregate runtime performance score to be lower than the corresponding aggregate simulated performance score for the GPU instance type. The aggregate runtime performance score can then be used to modify how the aggregate simulated performance score for that particular instance type is determined.

Thus, the next time the job is input into the heterogeneous cluster, the aggregated simulated performance score for the GPU instance type, which corresponds to the second aggregated simulated performance score, can be reduced due to adjustments resulting from the previously determined aggregate runtime performance score that reflected an inefficient execution on the GPU instance type. The second aggregated simulated performance score can be reduced by a predefined value, by a predefined factor, or any other predefined mathematical function.

With reference to FIG. 7, a plurality of workloads associated with the plurality of types of worker nodes on heterogeneous cluster 730 can be detected by a scaling module 718. A workload associated with a worker node group of a given instance type can be directly related to a level of usage of each of the one or more worker node groups for executing one or more transformation units of one or more jobs. The more jobs a worker node group has scheduled on it, the greater the workload. The fewer jobs a worker node group has scheduled on it, the lower the workload. Workload may be represented by, for example, a numerical value reflecting a percentage of nodes in the worker node group executing transformations of one or more jobs.

Because the heterogeneous cluster has a fixed amount of computing resources, the total usage across all worker node groups cannot exceed 100%. If scaling module 718 detects that a workload for a worker node group of a first instance type is high and a workload for a worker node group of a second instance type is low, then scaling module 718 can transmit instructions to control panel 740, causing scaler 735 to modify one or more worker nodes from the worker node group of the second type by, for example, taking those nodes offline, and modifying the worker nodes of the worker node group of the first instance type by, for example, bringing more nodes of the first instance type online, thereby increasing the number of nodes in the worker node group of the first instance type. Similarly, scaling module 718 can detect a high demand for a worker node group of a particular instance type and transmit instructions to control panel 740 that cause scaler 735 to increase the number of nodes of that particular instance type and reduce the number of nodes of other instance types. This scaling of nodes helps adjust the total usage of the computing resources of heterogeneous cluster 730 based on demand in order to achieve a more effective distribution of data execution, optimizing resource use and minimizing wasted computing.

Additionally, scaling module 218 can use preemption to remove nodes of an instance type serving fewer jobs (i.e. place the nodes offline) at lower workloads and add nodes (i.e. place node that are offline online) of an instance type needed by more jobs at higher workloads.

If scaling module 718 detects a workload that is low, it can transmit instructions to control panel 740 that cause scaler 735 to take a node offline. This avoids wasting resources of nodes that are not being used. Alternatively, if the scaling module detects a workload that is high, it can transmit instructions to control panel 740 that cause scaler 735 to bring more nodes online for a given instance type for which demand is greater without necessarily taking nodes of a different instance type offline.

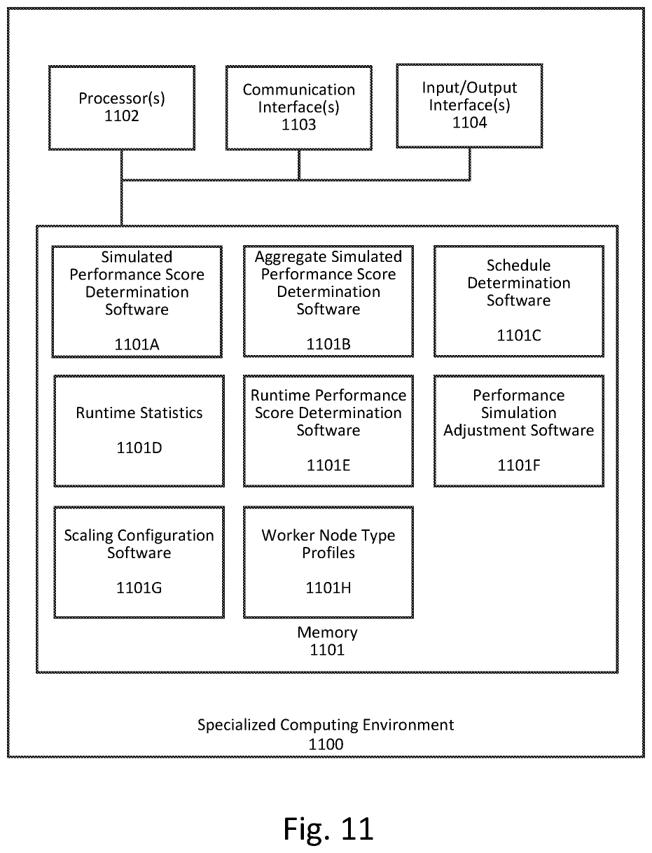

FIG. 11 illustrates the components of a specialized computing environment 1100 configured to perform the processes described herein. Specialized computing environment 1100 is a computing device that includes a memory 1101 that is a non-transitory computer-readable medium and can be volatile memory (e.g., registers, cache, RAM), non-volatile memory (e.g., ROM, EEPROM, flash memory, etc.), or some combination of the two. Specialized computing environment can be an application client communicatively coupled with one or more clusters.

As shown in FIG. 11, memory 1101 can store simulated performance score determination software 1101A, aggregate simulated performance score determination software 1101B, schedule determination software 1101C, runtime statistics 1101D, runtime performance score determination software 1101E, performance simulation adjustment software 1101F, scaling configuration software 1101G, and worker node type profiles 1101H. Each of the software components in memory 1101 store specialized instructions and data structures configured to perform the corresponding functionality and techniques described herein.

All of the software stored within memory 1101 can be stored as a computer-readable instructions, that when executed by one or more processors 1102, cause the processors to perform the functionality described with respect to FIGS. 1-10.

Processor(s) 1102 execute computer-executable instructions and can be a real or virtual processors. In a multi-processing system, multiple processors or multicore processors can be used to execute computer-executable instructions to increase processing power and/or to execute certain software in parallel.

Specialized computing environment 1100 additionally includes a communication interface 1803, such as a network interface, which is used to communicate with devices, applications, or processes on a computer network or computing system, collect data from devices on a network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Specialized computing environment 1100 further includes input and output interfaces 1804 that allow users (such as system administrators) to provide input to the system to display information, to edit data stored in memory 1101, or to perform other administrative functions.

An interconnection mechanism (shown as a solid line in FIG. 11), such as a bus, controller, or network interconnects the components of the specialized computing environment 1800.

Input and output interfaces 1104 can be coupled to input and output devices. For example, Universal Serial Bus (USB) ports can allow for the connection of a keyboard, mouse, pen, trackball, touch screen, or game controller, a voice input device, a scanning device, a digital camera, remote control, or another device that provides input to the specialized computing environment 1100.

Specialized computing environment 1100 can additionally utilize a removable or non-removable storage, such as magnetic disks, magnetic tapes or cassettes, CD-ROMs, CD-RWs, DVDs, USB drives, or any other medium which can be used to store information and which can be accessed within the specialized computing environment 1100.

Applicant has discovered a novel method, apparatus, and computer-readable medium for efficiently classifying a data object of unknown type. As explained above, the disclosed systems and methods are two to three times faster as compared to a traditional approach and achieve a two to three times reduction in the number of classification attempts before successful classification.

The disclosed systems and methods also provides a novel approach to choosing an order in which the data objects' classifiers should be queried and has many additional advantages. In particular, a lightweight data object model is used which can be instantiated both manually and automatically and is not computationally expensive to instantiate. The discloses system and method also allows users and systems to establish a threshold beyond which further classification attempts become irrelevant, saving resources on applying classifiers when the probability of success is low. The disclosed approach also makes blocking rules redundant and simplifies the overall data objects classification architecture. The implementation of the classification order predicting components is also transparent to the existing data objects' classification implementations, making it applicable to data objects of varied types.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

We claim:

1. A method for job scheduling on a heterogeneous cluster executed by one or more computing devices of an application client of the heterogeneous cluster, the method comprising:
receiving, by the application client, an application comprising at least one job, the at least one job comprising one or more transformation units, wherein each transformation unit is configured to perform a transformation on data input to the transformation unit;
determining, by the application client, a plurality of simulated performance scores for each transformation unit in the one or more transformation units, the plurality of simulated performance scores corresponding to a plurality of types of worker nodes in the heterogeneous cluster, wherein each type of worker node corresponds to a distinct hardware configuration and wherein each simulated performance score for each transformation unit is determined based at least in part on resources required for the transformation performed by the transformation unit and the distinct hardware configuration of a corresponding type of worker node;
determining, by the application client, a plurality of aggregate simulated performance scores for the at least one job, the plurality of aggregate simulated performance scores corresponding to the plurality of types of worker nodes, wherein each aggregate simulated performance score corresponds to a type of worker node and is determined based at least in part on simulated performance scores corresponding to that type of worker node for transformation units within the at least one job;
transmitting, by the application client, instructions to the heterogeneous cluster configured to cause the heterogeneous cluster to schedule the at least one job on one or more nodes of the heterogeneous cluster based at least in part on the plurality of aggregate simulated performance scores.

2. The method of claim 1, wherein the one or more nodes correspond to a first type of worker node, the method further comprising:
receiving, by the application client, execution statistics corresponding to execution of the at least one job on the one or more nodes of the heterogeneous cluster; and
determining, by the application client, an aggregate runtime performance score corresponding to the first type of worker node for the at least one job based at least in part on the execution statistics.

3. The method of claim 2, further comprising:
determining, by the application client, whether the aggregate simulated performance score corresponding to the first type of worker node for the at least one job exceeds the aggregate runtime performance score corresponding to the first type of worker node; and
adjusting, by the application client, one or more variables to indicate underperformance of the first type of worker node for the at least one job.

4. The method of claim 2, further comprising:
modifying, by the application client, a process used to determine each simulated performance score for the first type of worker node based at least in part on the aggregate runtime performance score.

5. The method of claim 1, further comprising:
receiving, by the application client, one or more of an application priority level for the application or a job priority level for the at least one job.

6. The method of claim 5, wherein the instructions configured to cause the heterogeneous cluster to schedule the at least one job on one or more nodes of the heterogeneous cluster based at least in part on the plurality of aggregate simulated performance scores are further configured to cause the heterogeneous cluster to schedule the at least one job on one or more nodes of the heterogeneous cluster based at least in part on the plurality of aggregate simulated performance scores and one or more of the application priority level or the job priority level.

7. The method of claim 1, further comprising:
detecting, by the application client, a plurality of workloads associated with the plurality of types of worker nodes on the heterogeneous cluster; and
transmitting, by the application client, instructions to the heterogeneous cluster configured to cause the heterogeneous cluster to modify a quantity of worker nodes of at least one type on the heterogeneous cluster based at least in part on the plurality of workloads.

8. The method of claim 1, wherein the at least one job comprises a plurality of stages and further comprising:
determining, by the application client, a plurality of stage-level aggregate simulated performance scores for each stage in the plurality of stages, the plurality of stage-level aggregate simulated performance scores corresponding to the plurality of types of worker nodes, wherein each stage-level aggregate simulated performance score corresponds to a type of worker node and is determined based at least in part on simulated performance scores corresponding to that type of worker node for transformation units within the stage; and
transmitting, by the application client, instructions to the heterogeneous cluster configured to cause the heterogeneous cluster to schedule the at least one job on one or more nodes of the heterogeneous cluster based at least in part on the plurality of stage-level aggregate simulated performance scores.

9. An application client for job scheduling on a heterogeneous cluster, the application client comprising:
one or more processors; and
one or more memories operatively coupled to at least one of the one or more processors and having instructions stored thereon that, when executed by at least one of the one or more processors, cause at least one of the one or more processors to:
receive an application comprising at least one job, the at least one job comprising one or more transformation units, wherein each transformation unit is configured to perform a transformation on data input to the transformation unit;
determine a plurality of simulated performance scores for each transformation unit in the one or more transformation units, the plurality of simulated performance scores corresponding to a plurality of types of worker nodes in the heterogeneous cluster, wherein each type of worker node corresponds to a distinct hardware configuration and wherein each simulated performance score for each transformation unit is determined based at least in part on resources required for the transformation performed by the transformation unit and the distinct hardware configuration of a corresponding type of worker node;
determine a plurality of aggregate simulated performance scores for the at least one job, the plurality of aggregate simulated performance scores corresponding to the plurality of types of worker nodes, wherein each aggregate simulated performance score corresponds to a type of worker node and is determined based at least in part on simulated performance scores corresponding to that type of worker node for transformation units within the at least one job;
transmit instructions to the heterogeneous cluster configured to cause the heterogeneous cluster to schedule the at least one job on one or more nodes of the heterogeneous cluster based at least in part on the plurality of aggregate simulated performance scores.

10. The application client of claim 9, wherein the one or more nodes correspond to a first type of worker node and wherein at least one of the one or more memories has further instructions stored thereon that, when executed by at least one of the one or more processors, cause at least one of the one or more processors to:
receive execution statistics corresponding to execution of the at least one job on the one or more nodes of the heterogeneous cluster; and
determine an aggregate runtime performance score corresponding to the first type of worker node for the at least one job based at least in part on the execution statistics.

11. The application client of claim 10, wherein at least one of the one or more memories has further instructions stored thereon that, when executed by at least one of the one or more processors, cause at least one of the one or more processors to:
determine whether the aggregate simulated performance score corresponding to the first type of worker node for the at least one job exceeds the aggregate runtime performance score corresponding to the first type of worker node; and
adjust one or more variables to indicate underperformance of the first type of worker node for the at least one job.

12. The application client of claim 10, wherein at least one of the one or more memories has further instructions stored thereon that, when executed by at least one of the one or more processors, cause at least one of the one or more processors to:
modify a process used to determine each simulated performance score for the first type of worker node based at least in part on the aggregate runtime performance score.

13. The application client of claim 9, wherein at least one of the one or more memories has further instructions stored thereon that, when executed by at least one of the one or more processors, cause at least one of the one or more processors to:
receive one or more of an application priority level for the application or a job priority level for the at least one job.

14. The application client of claim 13, wherein the instructions configured to cause the heterogeneous cluster to schedule the at least one job on one or more nodes of the heterogeneous cluster based at least in part on the plurality of aggregate simulated performance scores are further configured to cause the heterogeneous cluster to schedule the at least one job on one or more nodes of the heterogeneous cluster based at least in part on the plurality of aggregate simulated performance scores and one or more of the application priority level or the job priority level.

15. The application client of claim 9, wherein at least one of the one or more memories has further instructions stored thereon that, when executed by at least one of the one or more processors, cause at least one of the one or more processors to:
detect a plurality of workloads associated with the plurality of types of worker nodes on the heterogeneous cluster; and
transmit instructions to the heterogeneous cluster configured to cause the heterogeneous cluster to modify a quantity of worker nodes of at least one type on the heterogeneous cluster based at least in part on the plurality of workloads.

16. The application client of claim 9, wherein the at least one job comprises a plurality of stages and wherein at least one of the one or more memories has further instructions stored thereon that, when executed by at least one of the one or more processors, cause at least one of the one or more processors to:
determine a plurality of stage-level aggregate simulated performance scores for each stage in the plurality of stages, the plurality of stage-level aggregate simulated performance scores corresponding to the plurality of types of worker nodes, wherein each stage-level aggregate simulated performance score corresponds to a type of worker node and is determined based at least in part on simulated performance scores corresponding to that type of worker node for transformation units within the stage; and
transmit instructions to the heterogeneous cluster configured to cause the heterogeneous cluster to schedule the at least one job on one or more nodes of the heterogeneous cluster based at least in part on the plurality of stage-level aggregate simulated performance scores.

17. At least one non-transitory computer-readable medium storing computer-readable instructions for job scheduling on a heterogeneous cluster that, when executed by one or more computing devices of an application client, cause at least one of the one or more computing devices to:
receive an application comprising at least one job, the at least one job comprising one or more transformation units, wherein each transformation unit is configured to perform a transformation on data input to the transformation unit;
determine a plurality of simulated performance scores for each transformation unit in the one or more transformation units, the plurality of simulated performance scores corresponding to a plurality of types of worker nodes in the heterogeneous cluster, wherein each type of worker node corresponds to a distinct hardware configuration and wherein each simulated performance score for each transformation unit is determined based at least in part on resources required for the transformation performed by the transformation unit and the distinct hardware configuration of a corresponding type of worker node;
determine a plurality of aggregate simulated performance scores for the at least one job, the plurality of aggregate simulated performance scores corresponding to the plurality of types of worker nodes, wherein each aggregate simulated performance score corresponds to a type of worker node and is determined based at least in part on simulated performance scores corresponding to that type of worker node for transformation units within the at least one job;
transmit instructions to the heterogeneous cluster configured to cause the heterogeneous cluster to schedule the at least one job on one or more nodes of the heterogeneous cluster based at least in part on the plurality of aggregate simulated performance scores.

18. The at least one non-transitory computer-readable medium of claim 17, wherein the one or more nodes correspond to a first type of worker node and further storing computer-readable instructions that, when executed by at least one of the one or more computing devices, cause at least one of the one or more computing devices to:
receive execution statistics corresponding to execution of the at least one job on the one or more nodes of the heterogeneous cluster; and
determine an aggregate runtime performance score corresponding to the first type of worker node for the at least one job based at least in part on the execution statistics.

19. The at least one non-transitory computer-readable medium of claim 18, further storing computer-readable instructions that, when executed by at least one of the one or more computing devices, cause at least one of the one or more computing devices to:
determine whether the aggregate simulated performance score corresponding to the first type of worker node for the at least one job exceeds the aggregate runtime performance score corresponding to the first type of worker node; and
adjust one or more variables to indicate underperformance of the first type of worker node for the at least one job.

20. The at least one non-transitory computer-readable medium of claim 18, further storing computer-readable instructions that, when executed by at least one of the one or more computing devices, cause at least one of the one or more computing devices to:
modify a process used to determine each simulated performance score for the first type of worker node based at least in part on the aggregate runtime performance score.

21. The at least one non-transitory computer-readable medium of claim 17, further storing computer-readable instructions that, when executed by at least one of the one or more computing devices, cause at least one of the one or more computing devices to:
receive one or more of an application priority level for the application or a job priority level for the at least one job.

22. The at least one non-transitory computer-readable medium of claim 21, wherein the instructions configured to cause the heterogeneous cluster to schedule the at least one job on one or more nodes of the heterogeneous cluster based at least in part on the plurality of aggregate simulated performance scores are further configured to cause the heterogeneous cluster to schedule the at least one job on one or more nodes of the heterogeneous cluster based at least in part on the plurality of aggregate simulated performance scores and one or more of the application priority level or the job priority level.

23. The at least one non-transitory computer-readable medium of claim 17, further storing computer-readable instructions that, when executed by at least one of the one or more computing devices, cause at least one of the one or more computing devices to:
detect a plurality of workloads associated with the plurality of types of worker nodes on the heterogeneous cluster; and
transmit instructions to the heterogeneous cluster configured to cause the heterogeneous cluster to modify a quantity of worker nodes of at least one type on the heterogeneous cluster based at least in part on the plurality of workloads.

24. The at least one non-transitory computer-readable medium of claim 17, wherein the at least one job comprises a plurality of stages and further storing computer-readable instructions that, when executed by at least one of the one or more computing devices, cause at least one of the one or more computing devices to:
determine a plurality of stage-level aggregate simulated performance scores for each stage in the plurality of stages, the plurality of stage-level aggregate simulated performance scores corresponding to the plurality of types of worker nodes, wherein each stage-level aggregate simulated performance score corresponds to a type of worker node and is determined based at least in part on simulated performance scores corresponding to that type of worker node for transformation units within the stage; and
transmit instructions to the heterogeneous cluster configured to cause the heterogeneous cluster to schedule the at least one job on one or more nodes of the heterogeneous cluster based at least in part on the plurality of stage-level aggregate simulated performance scores.
